(19) United States
(12) Patent Application Publication
(10) Pub. No.: US 2014/0021775 A1
(43) Pub. Date: Jan. 23, 2014

(54) WHEEL HUB STRUCTURE FOR A BICYCLE

(71) Applicant: Bin Chang, Taichung City (TW)

(72) Inventor: Bin Chang, Taichung City (TW)

(21) Appl. No.: 13/592,279

(22) Filed: Aug. 22, 2012

(30) Foreign Application Priority Data
Jul. 18, 2012 (TW) 101125939

(51) Int. Cl. B60B 27/02

(52) U.S. Cl. 301/110.5

(57) ABSTRACT

A wheel hub structure for a bicycle includes a wheel hub having a hub body, a first wheel plate defined at one end of the hub body, a second wheel plate defined at another end of the hub body, a first extruded ring outwardly extruded from the first wheel plate, a second extruded ring outwardly extruded from the second wheel plate, a plurality of sleeving rings respectively sleeving an outer periphery of the first extruded ring and an outer periphery of the second extruded ring. Therefore, each sleeving ring of the first extruded ring or the second extruded ring reinforces a center structure of the first wheel plate or the second wheel plate.

### BACKGROUND OF THE INVENTION

1. Field of the Invention

The present invention relates to a wheel hub and more particularly to a wheel hub structure for a bicycle.

2. Description of Related Art

Bicycle activity is more and more popular in the 21st century because bicycle activity is eco-friendly, convenient and entertaining. Many enterprises encourage their employees to go to work by bicycles instead of driving vehicles today. Many people also go shopping or go traveling by bicycles during their leisure time. Because a wheel hub of a bicycle is very important for the comfort of riding, a conventional wheel hub structure for a bicycle comes to the world.

Referring to FIG. 1, the conventional wheel hub structure for a bicycle comprises a wheel hub 1, the wheel hub 1 having a hub body 11, a first wheel plate 111 defined at one end of the hub body 11, a second wheel plate 112 defined at another end of the hub body 11, the wheel hub 1 further having a ratchet base 10 and a spindle 12, the spindle 12 inserted into the hub body 11, the ratchet base 10 assembled at one end of the hub body 11, the wheel hub 1 assembled onto a fork (not shown) of the bicycle via the spindle 12, a wheel (not shown) connected to the first wheel plate 111 and the second wheel plate 112 of the wheel hub 1 of the bicycle via a plurality of spokes (not shown), a flywheel (not shown) assembled onto the ratchet base 10 so that the wheel is rotatable via the flywheel and the ratchet base 10. Under this arrangement, the bicycle is movable via the rotation of the wheel thereof.

However, the conventional wheel hub structure for a bicycle still has one disadvantage as following:

When a rider rides on a rough road, a pulling force and a pushing force from the spokes would deform the first wheel plate 111 and the second wheel plate 112 of the wheel hub 1, so that the whole wheel hub 1 would be further deformed; thereafter, the deformed hub body 11 presses against the ratchet base 10 and the spindle 12, so that the ratchet base 10 and the spindle 12 would be shifted relative to the original axis of the hub body 11; as a result, the connection between the ratchet base 10, the spindle 12 and the deformed hub body 11 would be destroyed. Therefore, it would be dangerous for the rider to ride a bicycle in which the whole wheel hub 1 has been deformed.

The present invention has arisen to mitigate and/or obviate the disadvantages of the conventional.

### SUMMARY OF THE INVENTION

The main objective of the present invention is to provide an improved wheel hub structure.

To achieve the objective, a wheel hub structure for a bicycle comprises a wheel hub having a hub body, a first wheel plate defined at one end of the hub body, a second wheel plate defined at another end of the hub body, a first extruded ring outwardly extruded from the first wheel plate, a second extruded ring outwardly extruded from the second wheel plate, a plurality of sleeving rings respectively sleeving an outer periphery of the first extruded ring and an outer periphery of the second extruded ring. Wherein, the hub body, the first wheel plate, the second wheel plate, the first extruded ring and the second extruded ring are integrated into the wheel hub as one piece; a plurality of connecting holes is opened around the assembling hole on the first wheel plate and the second wheel plate of the hub body; one distance between an inner surface and an outer surface of the sleeving ring of the first extruded ring is shorter than another distance between one periphery of each connecting hole of the first wheel plate and another periphery of the first extruded ring; one further distance between an inner surface and an outer surface of the sleeving ring of the second extruded ring is shorter than another further distance between one further periphery of each connecting hole of the second wheel plate and another further periphery of the second extruded ring; the wheel hub further has a ratchet base and a spindle; the ratchet base is assembled at one end of the hub body; the spindle is inserted into the ratchet base and the hub body; two ends of the spindle are respectively exposed from the ratchet base and the second extruded ring of the hub body.

Therefore, each sleeving ring of the first extruded ring or the second extruded ring reinforces a center structure of the first wheel plate or the second wheel plate.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a prior art;

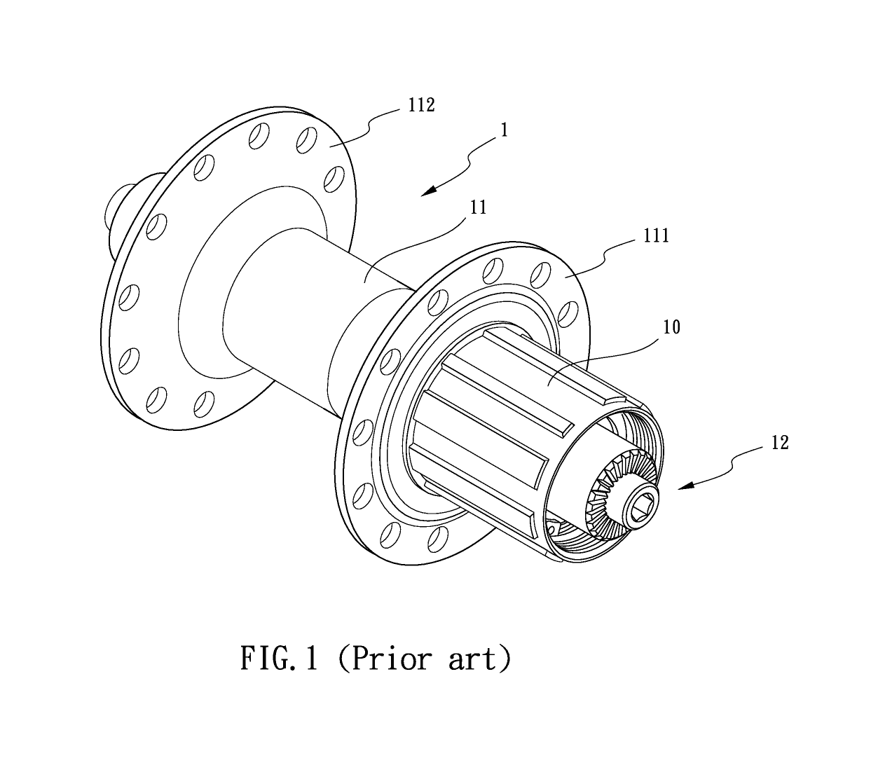

FIG. 2 is a perspective view of a wheel hub structure for a bicycle of the present invention;

FIG. 3 is a partially exploded view of the wheel hub structure for a bicycle;

FIG. 4 is a partially cross-sectional view for showing a sleeving ring which is assembled to a wheel hub;

FIG. 5 is another perspective view of a wheel hub structure for a bicycle;

FIG. 6 is another partially exploded view of the wheel hub structure for a bicycle; and

FIG. 7 is another partially cross-sectional view for showing two sleeving rings which are both assembled to the wheel hub.

### DETAILED DESCRIPTION OF THE INVENTION

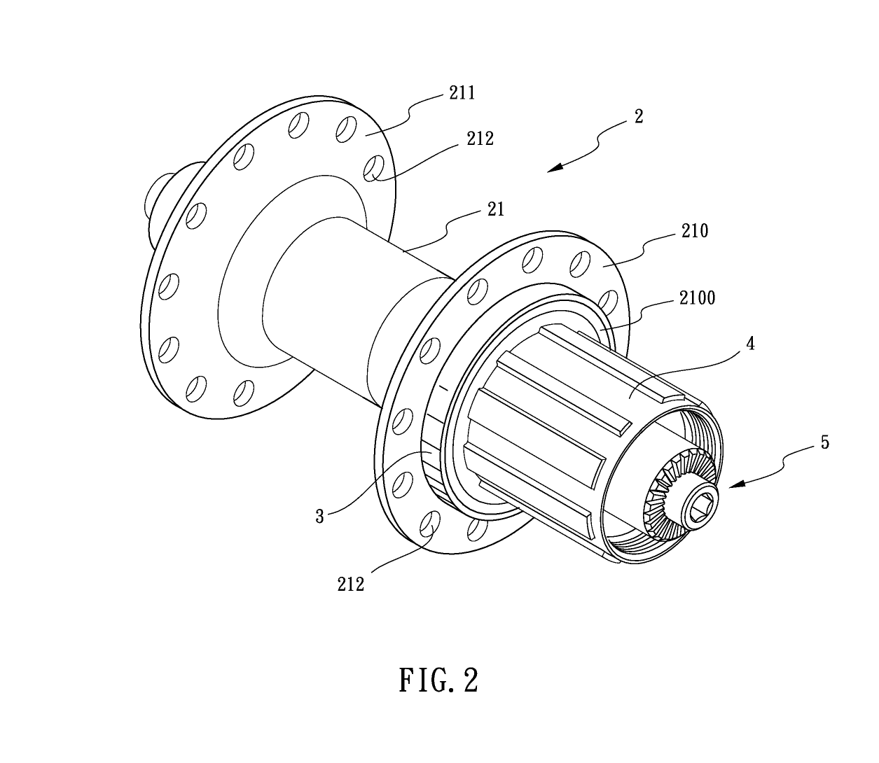

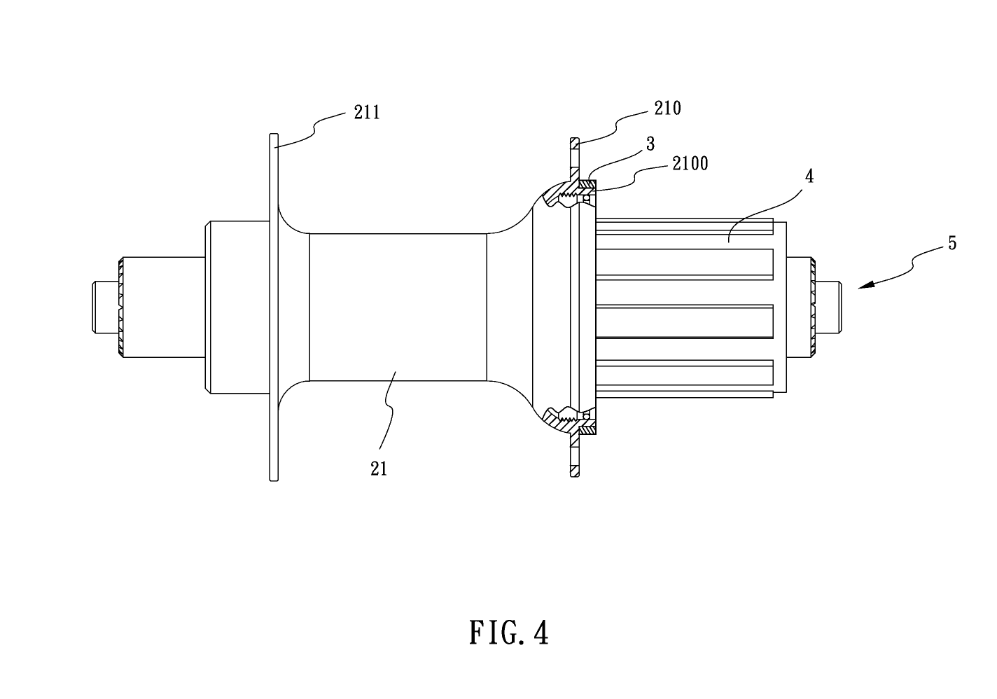

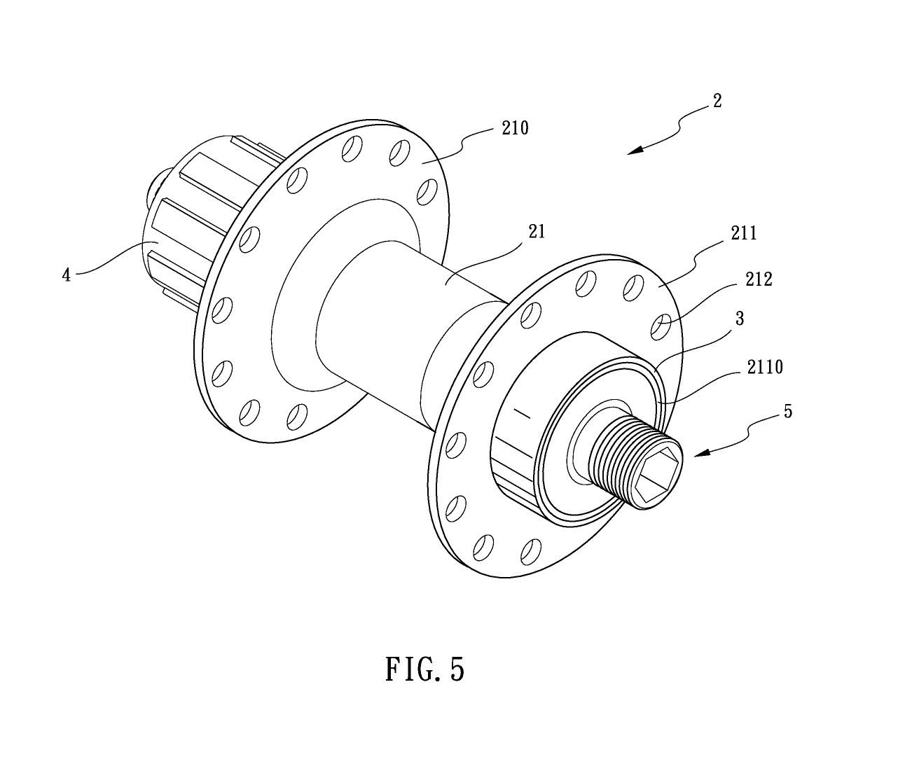

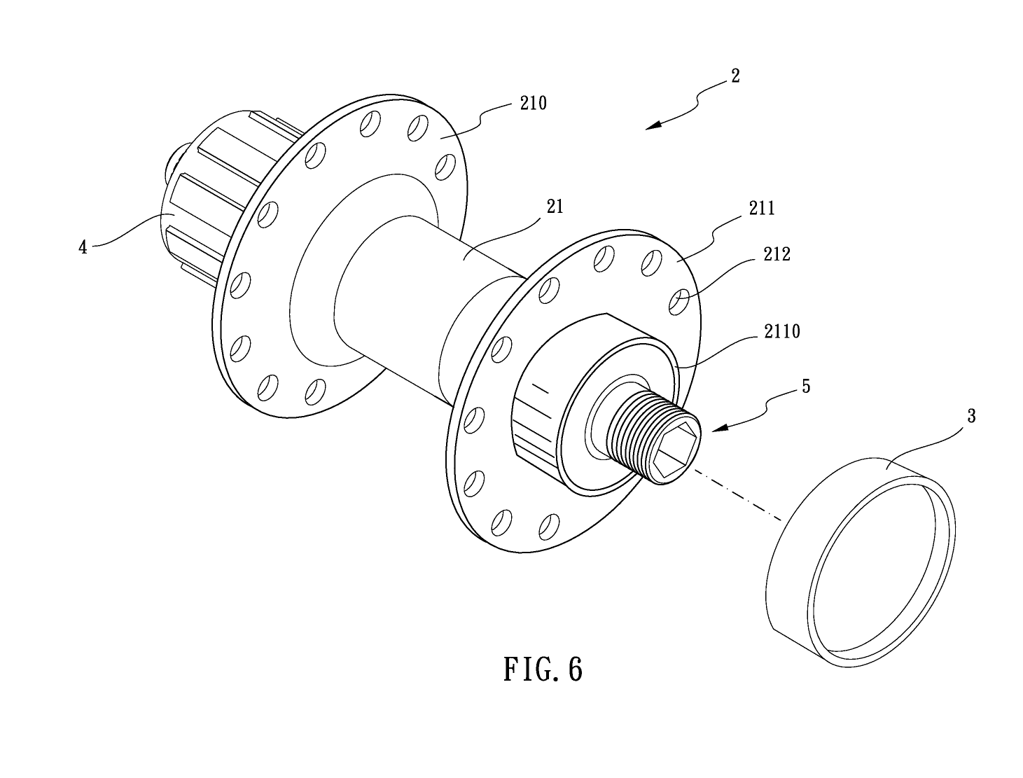

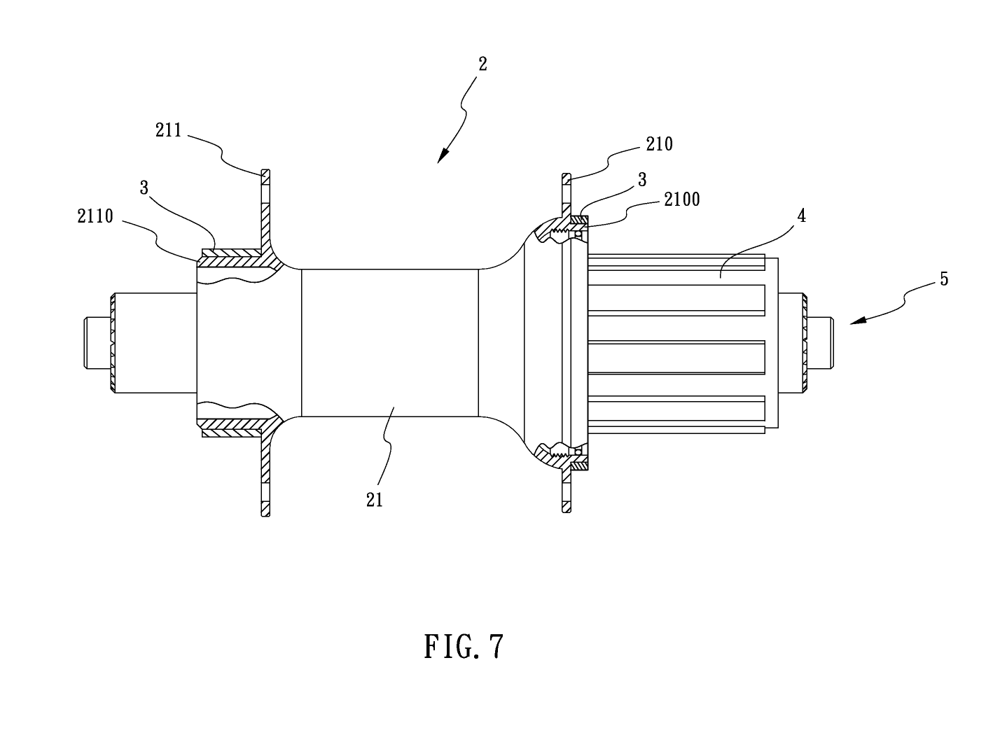

Referring to FIGS. 2-7, a wheel hub structure for a bicycle in accordance with the present invention comprises a wheel hub 2 and a plurality of sleeving rings 3. The wheel hub 2 has a hub body 21. A first wheel plate 210 is defined at one end of the hub body 21. A second wheel plate 211 is defined at another end of the hub body 21. A first extruded ring 2100 is outwardly extruded from the first wheel plate 210. A second extruded ring 2110 is outwardly extruded from the second wheel plate 211. The sleeving rings 3 respectively sleeve an outer periphery of the first extruded ring 2100 and an outer periphery of the second extruded ring 2110. A wheel connects to the wheel hub 2 via a plurality of spokes (not shown).

Under this arrangement, when a rider rides on a rough road, a pulling force and a pushing force from the spokes cannot deform the first extruded ring 2100 and the second extruded ring 2110, because each sleeving ring 3 of the first extruded ring 2100 or the second extruded ring 2110 resists the pulling force and the pushing force from the spokes. Therefore, the whole wheel hub 2 would not be deformed.

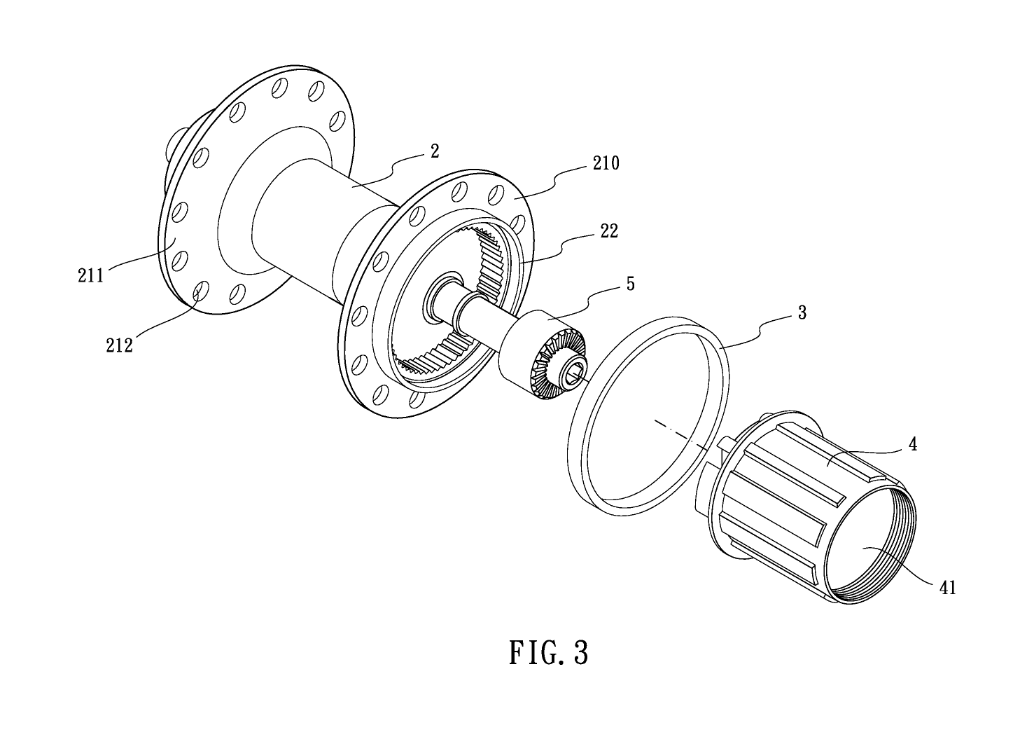

Referring to FIGS. 2-3, the wheel hub 2 further has a ratchet base 4 and a spindle 5. The ratchet base 4 is assembled at one end of the hub body 21. The hub body 21 has an assembling hole 22 opened therethrough. The ratchet base 4 has an enclosing hole 41 opened therethrough. The enclosing hole 41 of the ratchet base 4 communicates with the assembling hole 22 of the hub body 21. The spindle 5 is inserted into the enclosing hole 41 of the ratchet base 4 so as to be further inserted into the assembling hole 22 of the hub body 21. Two ends of the spindle 5 are respectively exposed from the ratchet base 4 and the second extruded ring 2110 of the hub body 21. The wheel hub 2 is assembled onto a fork (not shown) of the bicycle via the spindle 5. The wheel (not shown) is assembled to the wheel hub 2 of the bicycle via the first wheel plate 210 and the second wheel plate 211 of the hub body 21. A flywheel (not shown) is assembled onto the ratchet base 4 so that the wheel is rotatable via the flywheel and the ratchet base 4 (the detail of the ratchet base 4, the spindle 5 or the flywheel is well-known so that it would not be further described in the present invention.).

Referring to FIG. 2, a plurality of connecting holes 212 is opened around the assembling hole 22 on the first wheel plate 210 and the second wheel plate 211 of the hub body 21. One end of each spoke is connected to a rim of the wheel. Another end of each spoke is connected to each corresponding connecting hole 212 so that the wheel with the rim is connected to the first wheel plate 210 and the second wheel plate 211 of the wheel hub 2 via the spokes. Under this arrangement, when the wheel hub 2 is rotated by a user, the wheel is rotated by the rotation of the wheel hub 2.

Furthermore, one distance between an inner surface and an outer surface of the sleeving ring 3 of the first extruded ring 2100 is shorter than another distance between one periphery of each connecting hole 212 of the first wheel plate 210 and another periphery of the first extruded ring 2100. One further distance between an inner surface and an outer surface of the sleeving ring 3 of the second extruded ring 2110 is shorter than another further distance between one further periphery of each connecting hole 212 of the second wheel plate 211 and another further periphery of the second extruded ring 2110. Therefore, the sleeving ring 3 of the first extruded ring 2100 or the second extruded ring 2110 would not interfere with the connection between each spoke and each corresponding connecting hole 212. In addition, the sleeving ring 3 is connected to the first wheel plate 210 or the second wheel plate 211 via engaging, locking or adhesion . . . etc. (the method to connect the sleeving ring 3 to the first wheel plate 210 or the second wheel plate 211 is not limited by the present invention.). The hub body 21, the first wheel plate 210, the second wheel plate 211, the first extruded ring 2100 and the second extruded ring 2110 are integrated into the wheel hub 2 as one piece, so that a weight of the wheel hub 2 is reduced because an inner structure of the wheel hub 2 is simplified as the above description.

All in all, each sleeving ring 3 of the first extruded ring 2100 or the second extruded ring 2110 resists the pulling force and the pushing force from the spokes; in other wards, each sleeving ring 3 reinforces a center structure of the first wheel plate 210 or the second wheel plate 211. Therefore, when the rider rides on a rough road, the pulling force and the pushing force from the spokes cannot deform the first extruded ring 2100 and the second extruded ring 2110.

Although the invention has been explained in relation to its preferred embodiment, it is to be understood that many other possible modifications and variations can be made without departing from the spirit and scope of the invention as hereinafter claimed.

What is claimed is:

1. A wheel hub structure for a bicycle comprising:
a wheel hub having a hub body, a first wheel plate defined at one end of the hub body, a second wheel plate defined at another end of the hub body, a first extruded ring outwardly extruded from the first wheel plate, a second extruded ring outwardly extruded from the second wheel plate; and
a plurality of sleeving rings respectively sleeving an outer periphery of the first extruded ring and an outer periphery of the second extruded ring;
wherein, each sleeving ring of the first extruded ring or the second extruded ring reinforces a center structure of the first wheel plate or the second wheel plate.

2. The wheel hub structure for a bicycle as claimed in claim 1, wherein the hub body, the first wheel plate, the second wheel plate, the first extruded ring and the second extruded ring are integrated into the wheel hub as one piece.

3. The wheel hub structure for a bicycle as claimed in claim 1, wherein a plurality of connecting holes is opened around the assembling hole on the first wheel plate and the second wheel plate of the hub body.

4. The wheel hub structure for a bicycle as claimed in claim 2, wherein a plurality of connecting holes is opened around the assembling hole on the first wheel plate and the second wheel plate of the hub body.

5. The wheel hub structure for a bicycle as claimed in claim 3, wherein one distance between an inner surface and an outer surface of the sleeving ring of the first extruded ring is shorter than another distance between one periphery of each connecting hole of the first wheel plate and another periphery of the first extruded ring; one further distance between an inner surface and an outer surface of the sleeving ring of the second extruded ring is shorter than another further distance between one further periphery of each connecting hole of the second wheel plate and another further periphery of the second extruded ring.

6. The wheel hub structure for a bicycle as claimed in claim 1, wherein the wheel hub further has a ratchet base and a spindle; the ratchet base is assembled at one end of the hub body; the spindle is inserted into the ratchet base and the hub body; two ends of the spindle are respectively exposed from the ratchet base and the second extruded ring of the hub body.

7. The wheel hub structure for a bicycle as claimed in claim 5, wherein the wheel hub further has a ratchet base and a spindle; the ratchet base is assembled at one end of the hub body; the spindle is inserted into the ratchet base and the hub body; two ends of the spindle are respectively exposed from the ratchet base and the second extruded ring of the hub body.
